(19) United States
(12) Patent Application Publication
(10) Pub. No.: US 2026/0002593 A1
(43) Pub. Date: Jan. 1, 2026

(54) POPPET FOR VALVE, VALVE AND METHOD FOR CONTROLLING FLUID FLOW THROUGH THE VALVE

(71) Applicant: The Lee Company, Westbrook, CT (US)

(72) Inventor: Pavel Grigorash, New London, CT (US)

(21) Appl. No.: 19/242,535

(22) Filed: Jun. 18, 2025

Related U.S. Application Data
(60) Provisional application No. 63/665,486, filed on Jun. 28, 2024.
(60) Provisional application No. 63/665,925, filed on Jun. 28, 2024.
(60) Provisional application No. 63/754,196, filed on Feb. 5, 2025.

(51) Int. Cl. F16K 1/38; F16K 15/02

(52) U.S. Cl. CPC F16K 1/38; F16K 15/026

(57) ABSTRACT

A poppet for use in a valve assembly, including: a nose portion; ring portion; and a plurality of walls, the plurality of wall connecting the ring portion to the nose portion, wherein the plurality of walls define a first plurality of independent openings located between the nose portion and the ring portion.

### CROSS REFERENCE TO RELATED APPLICATIONS

This application claims priority to the following applications: U.S. Provisional Patent Application No. 63/665,486 filed on Jun. 28, 2024; U.S. Provisional Patent Application No. 63/665,925 filed on Jun. 28, 2024 and U.S. Provisional Patent Application No. 63/754,196 filed on Feb. 5, 2025, the entire contents each of which are incorporated herein by reference thereto.

### BACKGROUND

Exemplary embodiments of the present disclosure pertain to a poppet for use in a valve and a valve with the poppet of the present disclosure. Various embodiments of the present disclosure are also directed to a method for controlling fluid flow through a valve with the poppet of the present disclosure.

Assemblies for fluid flow control whether they be valves, flow restrictors or variable flow restrictors require at least two components that must be assembled together. The assemblies for fluid flow control include at least one input opening and at least one output opening that are in fluid communication with each other under certain operating conditions and the at least one input opening and at least one output opening are not in fluid communication with each other under other operating conditions. In order to provide the aforementioned fluid communication or lack thereof the assemblies for fluid flow control include a first component and a second component movably received within the first component.

As the fluid flows through the assembly there may be disturbances in the fluid flow. Accordingly, there is a desire to provide an apparatus for minimizing disturbances in fluid flow through the assembly and/or controlling fluid flow through the assembly.

### BRIEF DESCRIPTION

Disclosed is a poppet for use in a valve assembly, including: a nose portion; ring portion; and a plurality of walls, the plurality of wall connecting the ring portion to the nose portion, wherein the plurality of walls define a first plurality of independent openings located between the nose portion and the ring portion.

In addition to one or more of the features described above, or as an alternative to any of the foregoing embodiments, the nose portion is curved or conical in shape to provide a sealing surface.

In addition to one or more of the features described above, or as an alternative to any of the foregoing embodiments, the first plurality of independent openings are located at sides of the poppet.

In addition to one or more of the features described above, or as an alternative to any of the foregoing embodiments, each of the first plurality of independent openings are fluidly isolated from each other.

In addition to one or more of the features described above, or as an alternative to any of the foregoing embodiments, each of the plurality of walls extend from the ring portion until they reach an inner surface of the nose portion.

In addition to one or more of the features described above, or as an alternative to any of the foregoing embodiments, the plurality of walls are spaced from each other such that a second plurality of independent openings are defined between the plurality of walls and the ring portion.

In addition to one or more of the features described above, or as an alternative to any of the foregoing embodiments, a plurality of independent fluid flow paths through the poppet are defined by the first plurality of independent openings and the second plurality of independent openings.

In addition to one or more of the features described above, or as an alternative to any of the foregoing embodiments, the plurality of walls are spaced from each other such that a second plurality of independent openings are defined between the plurality of walls and the ring portion.

In addition to one or more of the features described above, or as an alternative to any of the foregoing embodiments, a plurality of independent fluid flow paths through the poppet are defined by the first plurality of independent openings and the second plurality of independent openings, each of the plurality of independent fluid flow paths through the poppet are fluidly isolated from each other.

In addition to one or more of the features described above, or as an alternative to any of the foregoing embodiments, an outer periphery of the ring portion is greater than an outermost periphery of the nose portion.

In addition to one or more of the features described above, or as an alternative to any of the foregoing embodiments, the plurality of walls are equally spaced from each other at an outer periphery of the poppet.

In addition to one or more of the features described above, or as an alternative to any of the foregoing embodiments, the plurality of walls are spaced from each other such that a second plurality of independent openings are defined between the plurality of walls and the ring portion and the plurality of walls are equally spaced from each other at an outer periphery of the poppet such that the first plurality of independent openings comprise four independent equally sized openings and the second plurality of independent openings comprise four independent equally sized openings.

In addition to one or more of the features described above, or as an alternative to any of the foregoing embodiments, the poppet is formed from a polymer.

Also disclosed is a valve assembly for fluid flow therethrough, including: a housing defining an inner cavity, the housing having a wall portion extending from an end portion of the housing, the wall portion and the end portion defining the inner cavity; a poppet, the poppet including: a nose portion; ring portion; and a plurality of walls, the plurality of wall connecting the ring portion to the nose portion, the plurality of walls define a first plurality of independent openings located between the nose portion and the ring portion, wherein the poppet is movably retained within the inner cavity of the housing for movement between a first position where the poppet seals an opening in the end portion of housing and at least a second position where the opening in the end portion of housing is not sealed by the poppet.

In addition to one or more of the features described above, or as an alternative to any of the foregoing embodiments, a biasing member is provided for maintaining the poppet in the first position.

In addition to one or more of the features described above, or as an alternative to any of the foregoing embodiments, the valve assembly is a check valve.

In addition to one or more of the features described above, or as an alternative to any of the foregoing embodiments, the first plurality of independent openings are located at sides of the poppet and each of the plurality of walls extend from the ring portion until they reach an inner surface of the nose portion and the plurality of walls are spaced from each other such that a second plurality of independent openings are defined between the plurality of walls and the ring portion.

In addition to one or more of the features described above, or as an alternative to any of the foregoing embodiments, a plurality of independent fluid flow paths through the poppet are defined by the first plurality of independent openings and the second plurality of independent openings.

In addition to one or more of the features described above, or as an alternative to any of the foregoing embodiments, the wall portion has an outwardly flared portion that extends away from the inner cavity at an open end of the housing, the open end being opposite to the end portion of the housing, the wall portion having a crimp proximate to the outwardly flared portion, the crimp extends towards the inner cavity.

Also disclosed is a method for reducing turbulence in a poppet of a valve assembly, including: moveably locating a poppet in an inner cavity of a housing of the valve assembly, the poppet being capable of movement between a first position where the poppet seals an opening in an end portion of housing and at least a second position where the opening in the end portion of housing is not sealed by the poppet, the poppet including: a nose portion; ring portion; and a plurality of walls, the plurality of wall connecting the ring portion to the nose portion, wherein the plurality of walls define a first plurality of independent openings located between the nose portion and the ring portion, the first plurality of independent openings are located at sides of the poppet and each of the plurality of walls extend from the ring portion until they reach an inner surface of the nose portion and the plurality of walls are spaced from each other such that a second plurality of independent openings are defined between the plurality of walls and the ring portion and a plurality of independent fluid flow paths through the poppet are defined by the first plurality of independent openings and the second plurality of independent openings, wherein fluid flow through the valve assembly occurs when the poppet is in the second position and the fluid flow through the valve assembly passes through plurality of independent fluid flow paths.

### BRIEF DESCRIPTION OF THE DRAWINGS

The following descriptions should not be considered limiting in any way. With reference to the accompanying drawings, like elements are numbered alike:

FIG. 1 is a perspective view of a fluid flow restricting member or poppet in accordance with the present disclosure;

FIG. 2 is a side of a fluid flow restricting member or poppet in accordance with the present disclosure;

FIG. 3 is top view of a fluid flow restricting member or poppet in accordance with the present disclosure;

FIG. 4 is a cross-sectional view of a fluid flow restricting member or poppet along lines 4-4 of FIG. 3 in accordance with the present disclosure;

FIG. 5 is side view of a housing in which the fluid flow restricting member or poppet in accordance with the present disclosure is movably received;

FIG. 6 is a partial perspective cross-sectional view of a valve assembly with the fluid flow restricting member or poppet in accordance with the present disclosure;

FIG. 7 is a partial cross-sectional view of a valve assembly with the fluid flow restricting member or poppet in a first or closed position in accordance with the present disclosure;

FIG. 8 is a cross-sectional view of a valve assembly with the fluid flow restricting member or poppet in a second or open position in accordance with the present disclosure;

FIG. 9 is a cross-sectional view of a valve assembly without the fluid flow restricting member or poppet in accordance with the present disclosure;

FIG. 10 is a cross-sectional view of a valve assembly with the fluid flow restricting member or poppet in a first or closed position in accordance with an alternative embodiment of the present disclosure;

FIG. 11 is a cross-sectional view of a valve assembly with the fluid flow restricting member or poppet in a second or open position in accordance with an alternative embodiment of the present disclosure;

FIG. 12 is a cross-sectional view of a valve assembly inserted into a conduit with the fluid flow restricting member or poppet in a first or closed position in accordance with an alternative embodiment of the present disclosure;

FIG. 13 is a cross-sectional view of a valve assembly inserted into a conduit with the fluid flow restricting member or poppet in a second or open position in accordance with an alternative embodiment of the present disclosure;

FIG. 14 is a cross-sectional view of a valve assembly inserted into a conduit with the fluid flow restricting member or poppet in accordance with another alternative embodiment of the present disclosure; and

FIG. 15 is a cross-sectional view of a valve assembly inserted into a housing with the fluid flow restricting member in accordance with an alternative embodiment of the present disclosure.

### DETAILED DESCRIPTION

A detailed description of one or more embodiments of the disclosed apparatus and method are presented herein by way of exemplification and not limitation with reference to the Figures.

Various embodiments of the present disclosure are directed to a unique fluid flow restricting member or poppet 10 having a bullet-shaped poppet design, with flow vanes 16, that reduce turbulence and thereby increase fluid flow through the fluid flow restricting member or poppet 10. The fluid flow through the restricting member or poppet 10 can be varied depending upon the dimensions of the restricting member or poppet 10. For example, the restricting member or poppet 10 can be scaled scaled up or down in diameter and length.

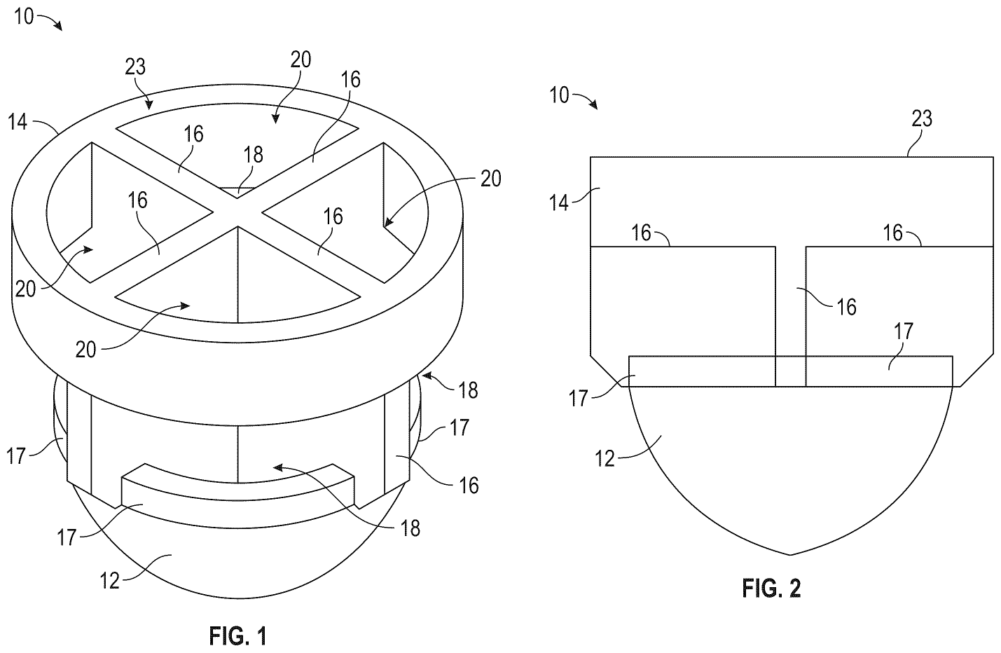

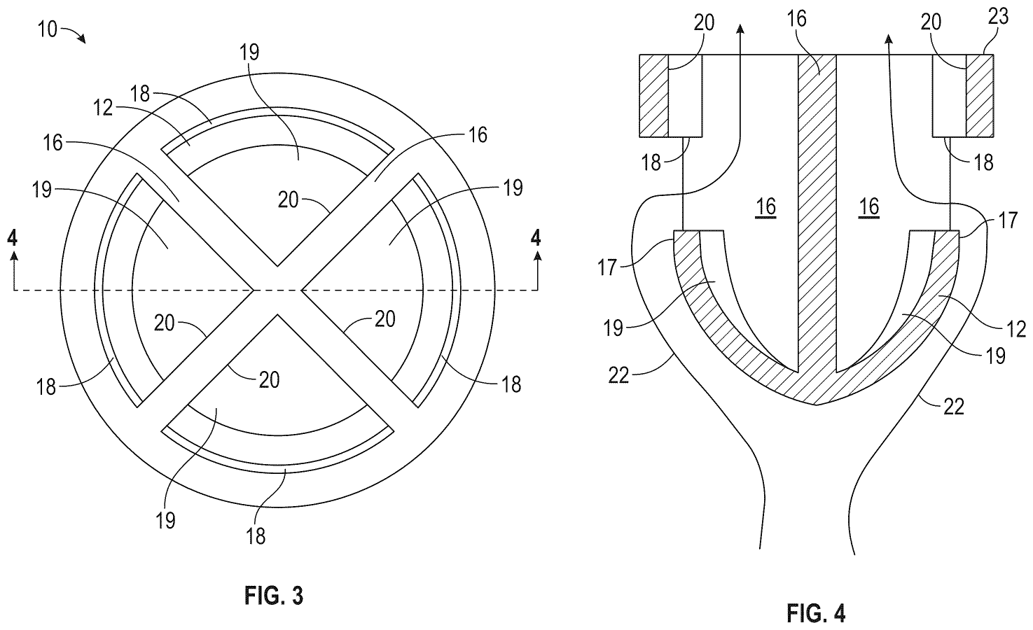

Referring now to at least FIGS. 1-4, a fluid flow restricting member or poppet 10 in accordance with the present disclosure is illustrated. In one non-limiting embodiment, the fluid flow restricting member or poppet 10 is used in a valve, check valve, poppet valve or valve assembly 30.

The fluid flow restricting member or poppet 10 includes a nose portion 12 connected to a ring portion 14 by a plurality of walls or flow vanes 16. The nose portion is curved or conical in shape to provide a sealing surface. The plurality of walls or flow vanes 16 define a plurality of independent openings or a first plurality of independent openings 18 located between the nose portion 12 and the ring portion 14. The plurality of independent openings or a first plurality of independent openings 18 are located at the sides of the fluid flow restricting member or poppet 10. In one non-limiting embodiment the curved or conically shaped sealing surface of the nose portion 12 transitions to a flat or non-curved surface 17 which terminates at a periphery of the plurality of independent openings or the first plurality of independent openings 18. Alternatively, the curved or conically shaped sealing surface of the nose portion 12 extends all the way to the periphery of the plurality of independent openings or the first plurality of independent openings 18.

Each of the plurality of independent openings or the first plurality of independent openings 18 are fluidly isolated from each other. Each of the walls or flow vanes 16 extend from the ring portion 14 until they reach an inner surface 19 of the nose portion 12. In addition, the walls or flow vanes 16 are spaced from each other such that a plurality of independent openings or a second plurality of independent openings 20 are defined between the walls or flow vanes 16 and the ring portion 14. Each of the plurality of independent openings or the second plurality of independent openings 20 are also fluidly isolated from each other. As such, a plurality of independent fluid paths 22 are defined by the fluid flow restricting member or poppet 10. Each of the plurality of independent fluid paths 22 through the fluid flow restricting member or poppet 10 are isolated from each other as they pass through the fluid flow restricting member or poppet 10. In one non-limiting exemplary embodiment, an outer periphery of the ring portion 14 is greater than an outermost periphery of the nose portion 12 such that when the fluid flow restricting member or poppet 10 is moveably received within a housing and a gap is provided in order to allow for fluid flow into openings 18. As used herein, independent openings 18 refers to openings 18 that are not in fluid communication with each other in the interior of the fluid flow restricting member or poppet 10. As used herein, independent openings 20 also refers to openings 20 that are not in fluid communication with each other in the interior of the fluid flow restricting member or poppet 10.

By providing a plurality of independent fluid flow paths 22 through the fluid flow restricting member or poppet 10 turbulence inside the fluid flow restricting member or poppet 10 is reduced as the independent fluid flow paths 22 through the fluid flow restricting member or poppet 10 do not merge with each other until they have exited a top or end 23 of the fluid flow restricting member or poppet 10. As such, the reduction of turbulence in the fluid flow restricting member or poppet 10 increases the fluid flow through the fluid flow restricting member or poppet 10. As used herein, independent fluid flow paths 22 refers to flow paths 22 that are not in fluid communication with each other in the interior of the fluid flow restricting member or poppet 10.

For example, and since the fluid flows into the fluid flow restricting member or poppet 10 by passing into the plurality of independent openings or a first plurality of independent openings 18 the vanes or walls 16 reduce the turbulence created by the fluid flow as they prevent the independent fluid flow paths 22 from interfering with each other inside the fluid flow restricting member or poppet 10. Still further, and since the walls or vanes 16 essentially define separate cavities in the fluid flow restricting member or poppet 10, each of the separate cavities are smaller in size if there was only one internal cavity in the fluid flow restricting member or poppet 10 that was in fluid communication with multiple openings 18 located between the nose portion 12 and the ring portion 14.

In one non-limiting embodiment, the walls or flow vanes 16 are equally spaced from each other at the outer periphery of the fluid flow restricting member or poppet 10. Still further and in one non-limiting embodiment, the walls or flow vanes 16 are equally spaced from each other at the outer periphery of the fluid flow restricting member or poppet 10 and four independent equally sized openings 18 and openings 20 are provided. Of course, the number and size of the openings 18 and 20 may vary and these openings 18 and 20 may have different sizes with respect to each other as opposed to being the same.

In one non-limiting exemplary embodiment, the fluid flow restricting member or poppet 10 is formed by a polymer or equivalents thereof. For example, the fluid flow restricting member or poppet 10 may be formed from an injection molding process.

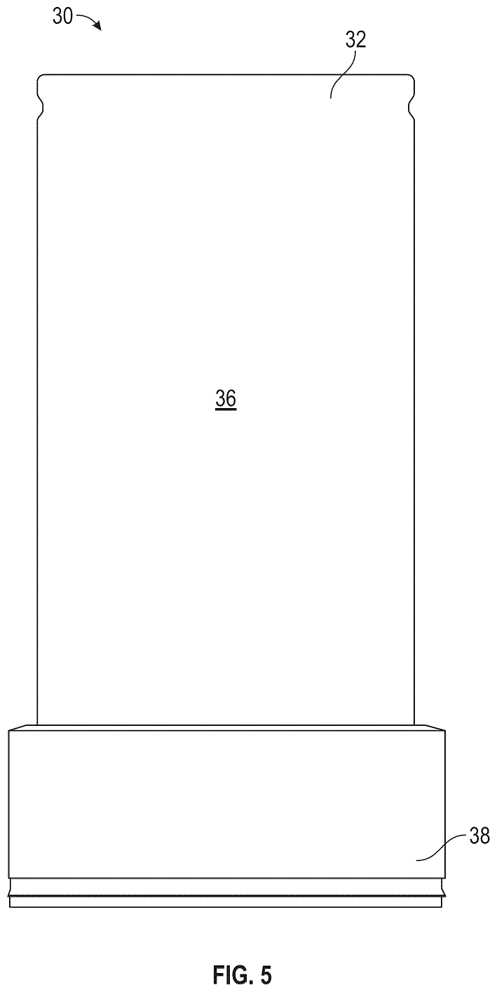

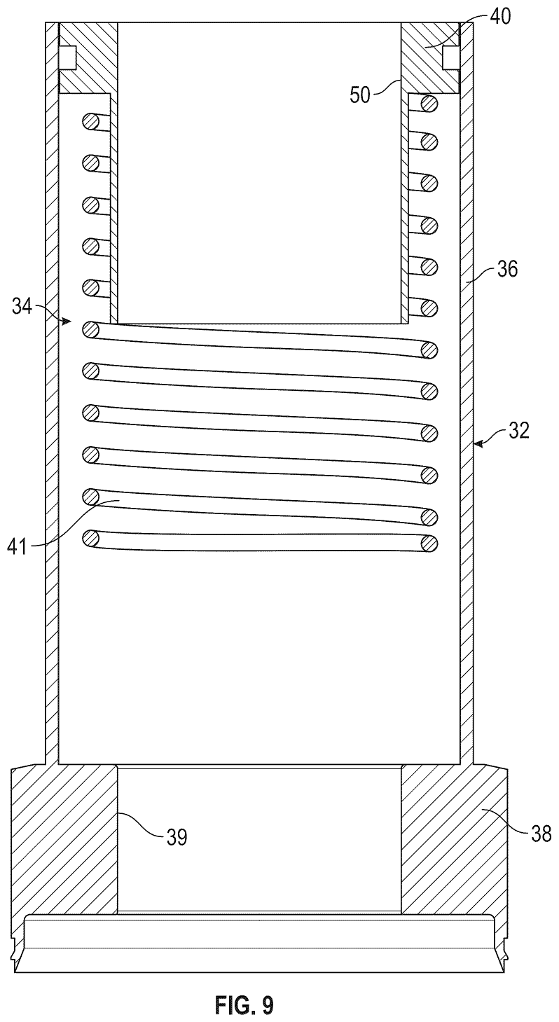

Referring now to at least FIGS. 5-9, an assembly 30 of the present disclosure is illustrated. As used herein “assembly” refers to at least two components assembled together in accordance with present disclosure. Here one of the two components is the fluid flow restricting member or poppet 10. The assembly 30 defines a fluid flow path through the assembly 30 which may be restricted, closed or opened depending on conditions on opposite ends of the fluid flow path through the assembly 30. In other words and as discussed herein, the assembly 30 may be a fluid flow restrictor that allows a limited amount of fluid flow in a first condition or first position and a greater amount of fluid flow in a second condition or second position. In one embodiment, the first condition or first position may always allow some amount of fluid flow through the assembly or alternatively the first condition or first position may prevent any fluid flow. As used herein “fluid” is intended to cover any liquid, gas or any other material that can flow or combinations thereof that may continuously move or deform under an applied shear stress or external force.

In accordance with various embodiments of the present disclosure, the assembly 30 includes a housing or body 32 and the fluid flow restricting member or poppet 10 as illustrated in at least FIGS. 1-4. The housing or body 32 defines an inner cavity 34 into which the fluid flow restricting member or poppet 10 is moveably received. The housing or body 32 has a wall portion 36 that extends from an end portion 38 of the housing or body 32. The end portion 38 defines at least one opening 39 that is sealed and unsealed by the nose portion 12 of the fluid flow restricting member or poppet 10. At an opposite end from the end portion 38 of the housing or body 32, an insert 40 is located into the inner cavity 34 of the housing or body 32. The insert 40 is secured to the housing or body 32 after the fluid flow restricting member or poppet 10 is located in the inner cavity 34.

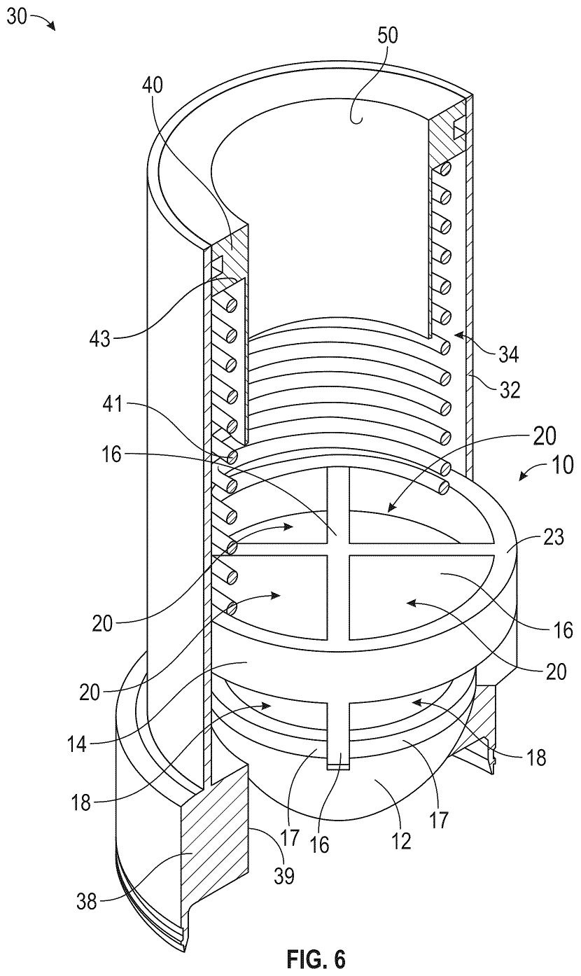

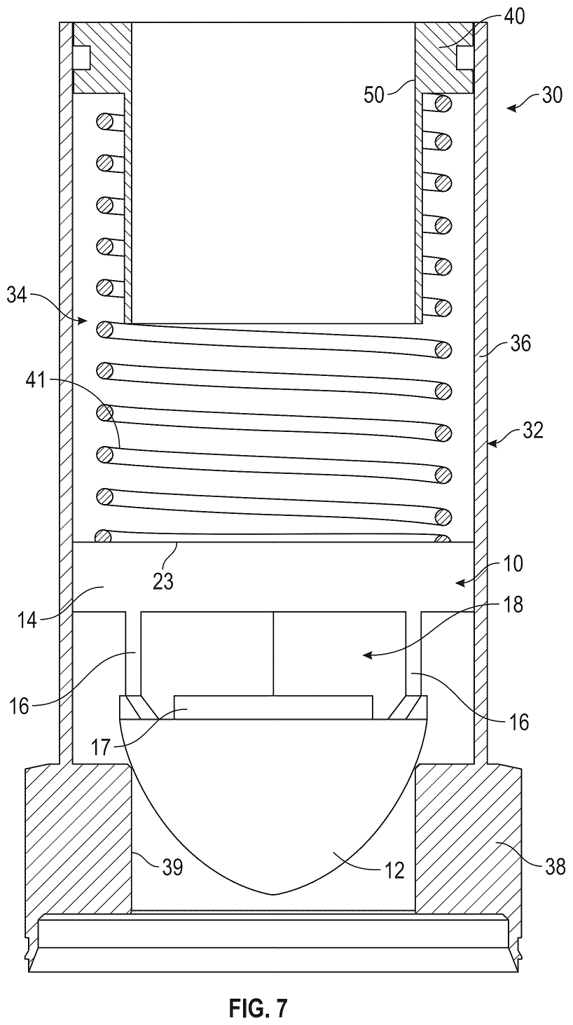

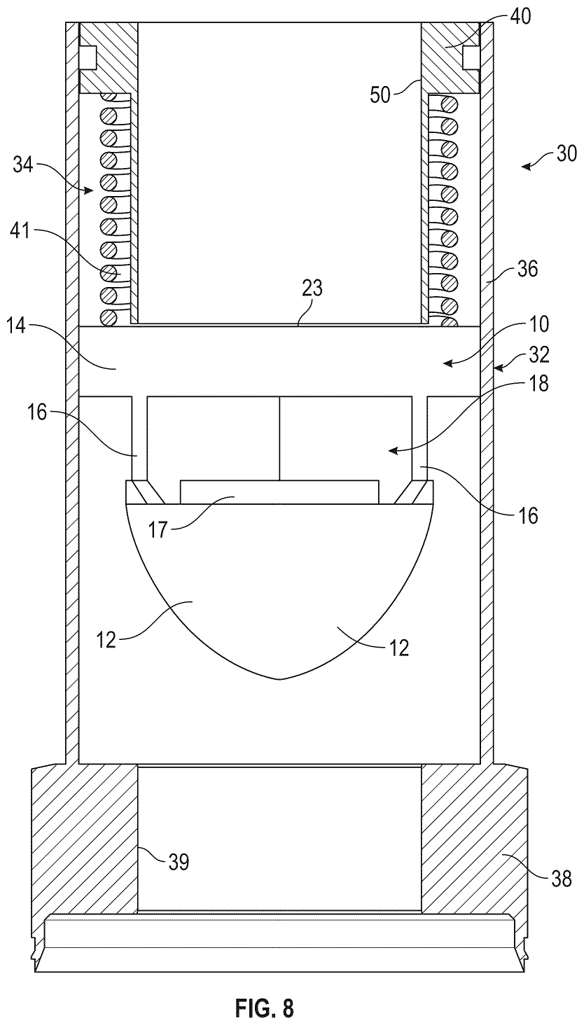

The insert 40 is secured to the housing or body 32 by any suitable process such as but not limited to crimping and/or friction fit and once secured to the housing or body 32 the insert 40 prevents the fluid flow restricting member or poppet 10 from being removed from the inner cavity 34 while also allowing the fluid flow restricting member or poppet 10 to move between at least the first position (see at least FIGS. 6 and 7) where the fluid flow restricting member or poppet 10 prevents fluid flow through the assembly 10 and the second position (see at least FIG. 8) where the fluid flow restricting member or poppet 10 allows fluid flow through the assembly 10.

In one non-limiting embodiment of the present disclosure and referring now to at least FIGS. 5-9, the fluid flow restricting member or poppet 10 is biased into a first condition or the first position by a biasing member or spring 41. Alternatively, the fluid flow restricting member or poppet 10 may be held in the first condition or first position by only a pressure differential on opposite sides of the fluid flow restricting member or poppet 10 or a combination of the pressure differential on opposite sides of the fluid flow restricting member or poppet 10 and the biasing force of the biasing member or spring 41. In either case and in one non-limiting embodiment of the present disclosure, the insert 40 provides a reaction surface 43 for the biasing member or spring 41 in the assembly 30 with the biasing member or the insert 40 provides the reaction surface 43 for the fluid flow restricting member or poppet 10 in the assembly 30 without the biasing member or spring 41.

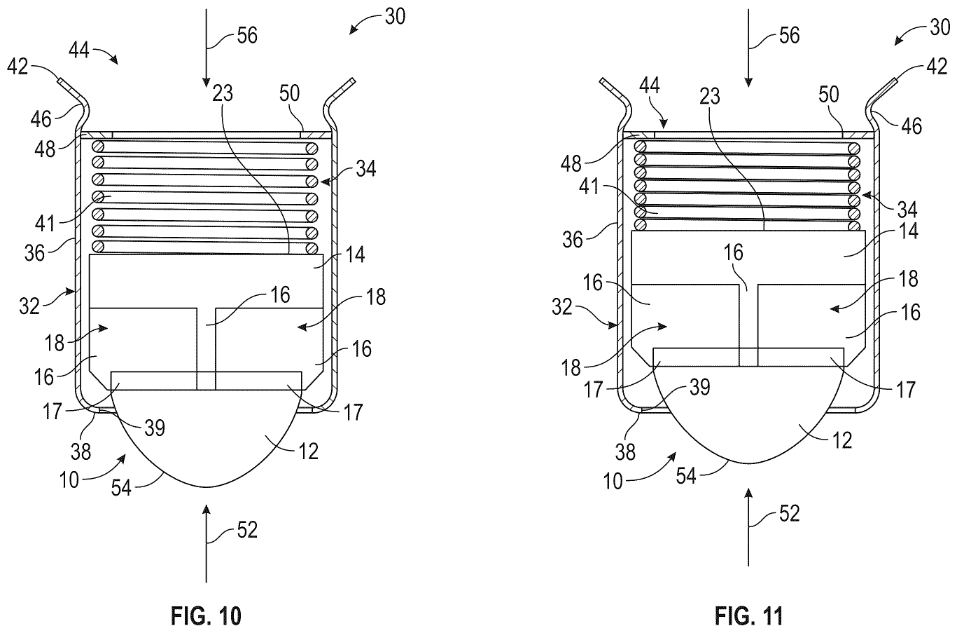

Referring now to at least FIGS. 10-14, yet another embodiment of the present disclosure is illustrated. Here the wall portion 36 of the housing or body 32 has an outwardly flared portion 42 that extends away from the inner cavity 34 at an open end 44 of the body 12. In one embodiment, the outwardly flared portion 22 is located at a distal end of the wall portion 36 of the housing or body 32.

The open end 44 being opposite to the end portion 38 of the housing or body 32. The wall portion 36 having at least one crimp 46 or a plurality of crimps 46 proximate to the outwardly flared portion 42, the at least one crimp 46 or plurality of crimps 46 extend towards the inner cavity 34. In other words, the outwardly flared portion 42 and the at least one crimp or plurality of crimps 46 extend in opposite directions.

In accordance with various non-limiting embodiments of the present disclosure, the body or housing 32 comprising the wall portion 36 and/or the end portion 38 defines a cylindrical or generally cylindrical body. In accordance with one non-limiting embodiment of the present disclosure and referring in particular to the embodiment of FIGS. 10-14, the body or housing 32 comprising the wall portion 36 and/or the end portion 38 is formed from metal or an alloy such as steel or stainless steel. Of course, other materials are contemplated to be within the scope of the present disclosure as long as they are capable of being deflected and formed as described herein.

In accordance with various non-limiting embodiments of the present disclosure, a plurality of separate crimps 46 are provided in the wall portion 36 or the crimp is a single crimp 46 that circumscribes or extends about the inner periphery of the inner cavity 34 defined by the wall portion 36.

In accordance with various embodiments of the present disclosure the fluid flow restricting member or poppet 10 is moveably received within the inner cavity 34 for movement between at least a first position (see at least FIGS. 10, 12 and 14) where the fluid flow restricting member or poppet 10 reduces or prevents fluid flow through the inner cavity 34 and a second position (see at least FIGS. 11 and 13) where the fluid flow restricting member or poppet 10 allows or increases a fluid flow through the inner cavity 34.

In accordance with various embodiments of the present disclosure the at least one crimp or the plurality of crimps 46 are formed in the wall portion 36 of the body 32 after the fluid flow restricting member or poppet 10 is inserted into the inner cavity 34. The at least one crimp 46 or plurality of crimps 46 extend into the inner cavity 34 and the fluid flow restricting member or poppet 10 and the at least one crimp 46 or the plurality of crimps 46 prevent the fluid flow restricting member or poppet 10 from being completely dislodged from the inner cavity 34 after the at least one crimp 46 or the plurality of crimps 46 are formed in the wall portion 36 of the body 32.

In one non-limiting embodiment of the present disclosure, the fluid flow restricting member or poppet 10 is retained in the inner cavity 34 by a stop member 48 that is also inserted into the inner cavity 34 prior to the forming of the at least one crimp 46 or the plurality of crimps 46 in the wall portion 36 of the body 32. In one non-limiting embodiment, the stop member 48 is a circular member or disc having an outer dimension or diameter that is slightly less than an inner dimension or diameter of the inner cavity and the stop member 48 has at least one inner opening 50 to allow fluid flow therethrough. In the embodiment illustrated in at least FIGS. 5-9, the insert 40 has at least one opening 50 providing fluid communication into the inner cavity 34.

In one non-limiting embodiment of the present disclosure and referring now to at least FIGS. 5-14, the fluid flow restricting member or poppet 10 is biased into a first condition or the first position by the biasing member or spring 41. Note the biasing member or spring 41 is not always shown in the attached FIGS. Alternatively, the fluid flow restricting member or poppet 10 may be held in the first condition or first position by only a pressure differential on opposite sides of the fluid flow restricting member or poppet 10 or a combination of the pressure differential on opposite sides of the fluid flow restricting member or poppet 10 and the biasing force of the biasing member or spring 41. In either case and in one non-limiting embodiment of the present disclosure, the stop member 38 or insert 40 provides a reaction surface for the biasing member or spring 41 in the assembly 30 with the biasing member or spring 41 or a reaction surface for the fluid flow restricting member or poppet 10 in the assembly 30 without the biasing member or spring 41.

As illustrated, the end portion 38 of the body 32 includes the opening 39. The opening 39 illustrated in the embodiment of FIGS. 10-15, is in one non-limiting embodiment formed in the end portion 38 by a coining process or step. Alternatively, and in the embodiment of at least FIGS. 5-9, the opening 39 in the end portion may be formed by a molding process used to form the end portion of the housing or body 32. The opening 39 is configured to be sealed or partially closed by the fluid flow restricting member or poppet 10 when the fluid flow restricting member or poppet 10 is in the first position or first condition.

In one non-limiting embodiment, the fluid flow restricting member or poppet 10 completely seals opening 39 when it is in the first position. For example and as illustrated in at least FIGS. 1, 2, 4, 6, 7, 8, 10 and 12, the fluid flow restricting member or poppet 10 has a sealing portion or nose portion 12 that completely seals opening 39 when the fluid flow restricting member or poppet 10 is in the first position.

In one embodiment, and when the assembly 30 does not include a biasing member or spring 41, the fluid flow restricting member or poppet 10 is retained in the first position or moved from the first position toward the second position and vice versa by a difference in fluid flow pressures acting upon opposite sides of the fluid flow restricting member or poppet 10.

For example, and when a fluid flow pressure or difference in fluid pressure, delta P (ΔP) acting on a side of the end portion 38 that is opposite to the inner cavity 34 is greater than the fluid flow pressure or difference in fluid pressure, delta P (ΔP) acting on a side of the end portion 38 that faces the inner cavity 34, the fluid flow restricting member or poppet 10 will move in the direction of arrow 52 away from the first position such that the sealing portion or nose portion 12 is no longer seated about opening 39. In other words, the sealing portion or nose portion 12 of the fluid flow restricting member or poppet 10 has a contact surface 54 that seals opening 39 when the fluid flow restricting member or poppet 10 is in the first position. In one non-limiting embodiment, the contact surface 54 has a curved surface in order to assist with the sealing of opening 39 when the fluid flow restricting member or poppet 10 is in the first position.

Conversely, and when a fluid flow pressure or difference in fluid pressure, delta P (ΔP) acting on a side of the end portion 38 that is opposite to the inner cavity 34 is lesser than the fluid flow pressure or difference in fluid pressure, delta P (ΔP) acting on a side of the end portion 38 that faces the inner cavity 34, the fluid flow restricting member or poppet 10 will move in the direction of arrow 56 towards the first position such that the sealing portion or nose portion 12 is seated about opening 39. In other words, the sealing portion or nose portion 12 of the fluid flow restricting member or poppet 10 has a contact surface 54 that seals opening 39 when the fluid flow restricting member or poppet 10 is in the first position. For example, and when the fluid flow restricting member or poppet 10 is in a second position or any position other than the first position when the sealing portion or nose portion 12 is not seated about opening 39 and the aforementioned differences in fluid flow pressures occurs on opposite sides of the sealing portion or nose portion 12 the fluid flow restricting member or poppet 10 will be moved from a position or second position where fluid flow is allowed through the assembly 30 to the first position where the sealing portion or nose portion 12 is seated about opening 39.

As previously mentioned and in one non-limiting embodiment, the fluid flow restricting member or poppet 10 is retained the first position by a biasing force of spring or biasing member 41 in the direction of arrow 56. In this embodiment, and in order to move the fluid flow restricting member or poppet 10 in the direction of arrow 52 away from the first position, the fluid flow pressure or difference in fluid pressure, delta P (ΔP) acting on a side of the end portion 38 that is opposite to the inner cavity 34 must be greater than the fluid flow pressure or difference in fluid pressure, delta P (ΔP) acting on a side of the end portion 38 that faces the inner cavity 34 and the biasing force of the spring or biasing member 41 in the direction of arrow 56.

In one alternative non-limiting embodiment, the fluid flow restricting member or poppet 10 defines a cavity (not shown) for retaining a portion or end of the biasing member 41 therein.

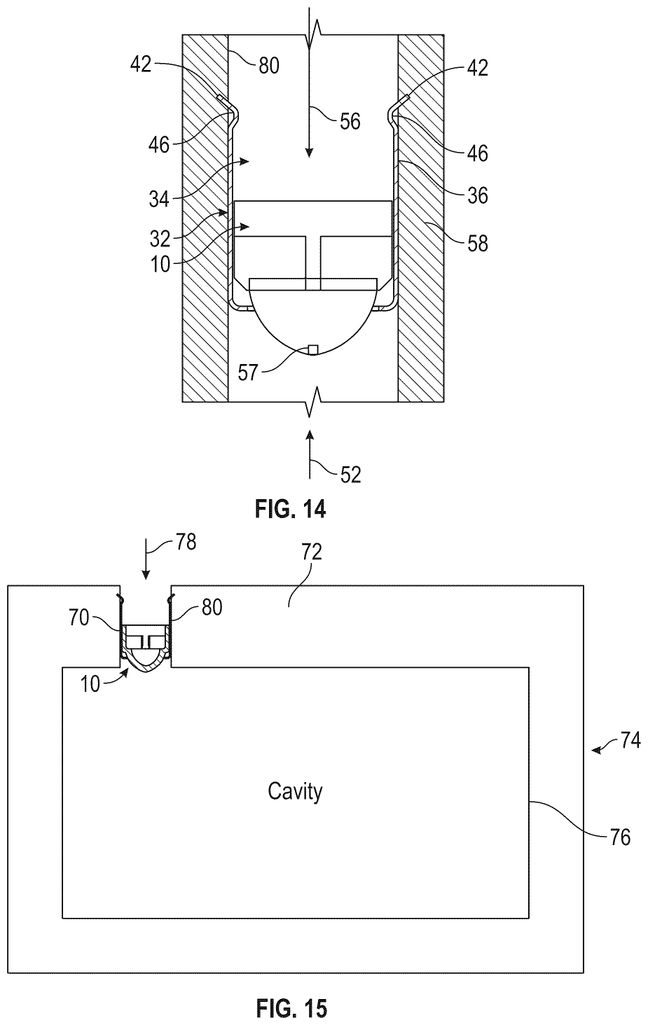

Alternatively and as illustrated in FIG. 14, the sealing portion or nose portion 12 may have an opening 57 or a plurality of openings 57 extending therethrough. In this embodiment, the opening 57 or plurality of openings 57 always provide a fluid flow path through the sealing portion or nose portion 12 regardless of the position of the fluid flow restricting member or poppet 10. In other words, the assembly 30 may be referred to as a flow restricting assembly 30 while there is always a flow through the assembly 30 (e.g., a smaller flow rate when the fluid flow restricting member or poppet 10 is in the first position and a larger flow rate when the fluid flow restricting member or poppet 10 is moved away from the first position towards the second position due to an increased delta P (ΔP) as system pressure increases.

Alternatively and as previously mentioned, the fluid flow restricting member or poppet 10 in one embodiment does not have opening 57 or a plurality of openings 57. As such and in this embodiment, the fluid flow through the assembly 30 only occurs when the fluid flow restricting member or poppet 10 is in the second position when the fluid flow restricting member or poppet 10 is moved away from the first position towards the second position. In this embodiment, the assembly 30 may be referred to a valve, valve assembly or check valve.

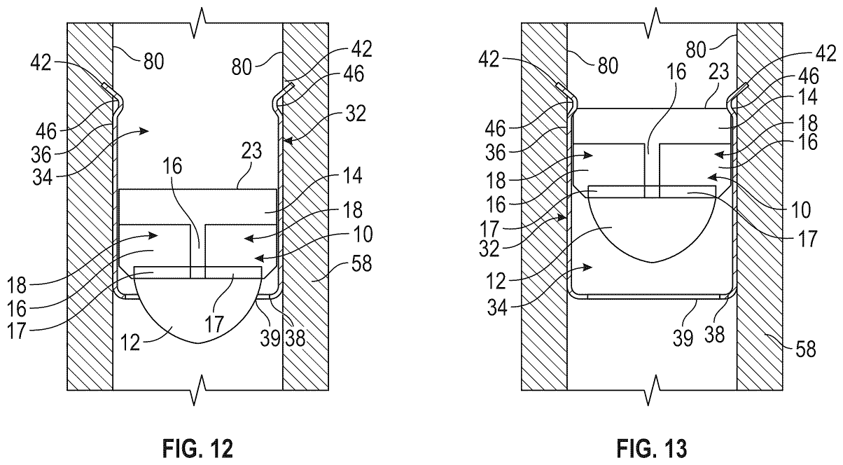

As mentioned above and in some embodiments, the wall portion 36 has an outwardly flared portion 42 that extends away from the inner cavity 34 at an open end 44 of the body 32. The outwardly flared portion 42 circumscribes the entire periphery of the open end 44 of the body 32 and the outwardly flared portion 42 extends furthest from the wall portion 36. This allows the outwardly flared portion 42 to retain the assembly 30 in a conduit or hose 58 (see at least FIGS. 12 and 13) or an opening 70 in a wall 72 (see FIG. 15) of a housing 74 that defines a cavity 76 of the housing 74. As such, the assembly 30 when inserted into the conduit or hose 58 or opening 70 in wall 72 in the direction of arrows 78 an outermost edge of the outwardly flared portion 42 will engage a surface 80 of the conduit or hose 58 or opening 70 in wall 72 in order to retain the assembly 30 in conduit or hose 58 or opening 70 in wall 72. In one embodiment, the conduit or hose 58 is made of rubber, plastic, nylon or any material of being engaged by the outermost edge of the outwardly flared portion 42 when it is inserted therein.

As illustrated, the body 32 and/or the end portion 38 that defines a cylindrical or generally cylindrical body 32 has a dimension that is slightly less than a diameter of the conduit or hose 58 or opening 70 in wall 72 such that the assembly 30 can be inserted and slide therein in the direction of arrow 78 during valve installation in the conduit or hose 58 or opening 70 in wall 72 and then the outermost edge of the outwardly flared portion 42 will engage surface 80 of the conduit or hose 58 or opening 70 in wall 72 in order to retain the assembly 30 in its desired location withing the conduit or hose 58 or opening 70 in wall 72 as fluid flow pressures on opposite sides of the assembly 30 vary thus preventing it from being removed from the conduit or hose 58 or opening 70 in wall 72 in a direction opposite to arrow 78. In other words, the outermost edge of the outwardly flared portion 42 will allow for movement in the direction of arrow 78 during valve installation in the conduit or hose 58 or opening 70 in wall 72 but prevent movement in a direction opposite to arrow 78 once the assembly 30 is in its desired location within conduit or hose 58 or opening 70 in wall 72.

While various configurations of the housing or body 32 is illustrated in the attached Figures it is understood that in accordance with the present disclosure, the housing or body 32 of the assembly 30 is not specifically limited to the configurations illustrated in the attached Figures.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A poppet for use in a valve assembly, comprising:
a nose portion;
ring portion; and
a plurality of walls, the plurality of wall connecting the ring portion to the nose portion, wherein the plurality of walls define a first plurality of independent openings located between the nose portion and the ring portion.

2. The poppet as in claim 1, wherein the nose portion is curved or conical in shape to provide a sealing surface.

3. The poppet as in claim 1, wherein the first plurality of independent openings are located at sides of the poppet.

4. The poppet as in claim 1, wherein each of the first plurality of independent openings are fluidly isolated from each other.

5. The poppet as in claim 1, wherein each of the plurality of walls extend from the ring portion until they reach an inner surface of the nose portion.

6. The poppet as in claim 5, wherein the plurality of walls are spaced from each other such that a second plurality of independent openings are defined between the plurality of walls and the ring portion.

7. The poppet as in claim 6, wherein a plurality of independent fluid flow paths through the poppet are defined by the first plurality of independent openings and the second plurality of independent openings.

8. The poppet as in claim 1, wherein the plurality of walls are spaced from each other such that a second plurality of independent openings are defined between the plurality of walls and the ring portion.

9. The poppet as in claim 8, wherein a plurality of independent fluid flow paths through the poppet are defined by the first plurality of independent openings and the second plurality of independent openings, each of the plurality of independent fluid flow paths through the poppet are fluidly isolated from each other.

10. The poppet as in claim 1, wherein an outer periphery of the ring portion is greater than an outermost periphery of the nose portion.

11. The poppet as in claim 1, wherein the plurality of walls are equally spaced from each other at an outer periphery of the poppet.

12. The poppet as in claim 1, wherein the plurality of walls are spaced from each other such that a second plurality of independent openings are defined between the plurality of walls and the ring portion and the plurality of walls are equally spaced from each other at an outer periphery of the poppet such that the first plurality of independent openings comprise four independent equally sized openings and the second plurality of independent openings comprise four independent equally sized openings.

13. The poppet as in claim 1, wherein the poppet is formed from a polymer.

14. A valve assembly for fluid flow therethrough, comprising:
a housing defining an inner cavity, the housing having a wall portion extending from an end portion of the housing, the wall portion and the end portion defining the inner cavity;
a poppet, the poppet including:
a nose portion;
ring portion; and
a plurality of walls, the plurality of wall connecting the ring portion to the nose portion, the plurality of walls define a first plurality of independent openings located between the nose portion and the ring portion, wherein the poppet is movably retained within the inner cavity of the housing for movement between a first position where the poppet seals an opening in the end portion of housing and at least a second position where the opening in the end portion of housing is not sealed by the poppet.

15. The valve assembly as in claim 14, further comprising:
a biasing member maintaining the poppet in the first position.

16. The valve assembly as in claim 14, wherein the valve assembly is a check valve.

17. The valve assembly as in claim 14, wherein the first plurality of independent openings are located at sides of the poppet and each of the plurality of walls extend from the ring portion until they reach an inner surface of the nose portion and the plurality of walls are spaced from each other such that a second plurality of independent openings are defined between the plurality of walls and the ring portion.

18. The valve assembly as in claim 17, wherein a plurality of independent fluid flow paths through the poppet are defined by the first plurality of independent openings and the second plurality of independent openings.

19. The valve assembly as in claim 14, wherein the wall portion has an outwardly flared portion that extends away from the inner cavity at an open end of the housing, the open end being opposite to the end portion of the housing, the wall portion having a crimp proximate to the outwardly flared portion, the crimp extends towards the inner cavity.

20. A method for reducing turbulence in a poppet of a valve assembly, comprising:
moveably locating a poppet in an inner cavity of a housing of the valve assembly, the poppet being capable of movement between a first position where the poppet seals an opening in an end portion of housing and at least a second position where the opening in the end portion of housing is not sealed by the poppet, the poppet including: a nose portion; ring portion; and a plurality of walls, the plurality of wall connecting the ring portion to the nose portion, wherein the plurality of walls define a first plurality of independent openings located between the nose portion and the ring portion, the first plurality of independent openings are located at sides of the poppet and each of the plurality of walls extend from the ring portion until they reach an inner surface of the nose portion and the plurality of walls are spaced from each other such that a second plurality of independent openings are defined between the plurality of walls and the ring portion and a plurality of independent fluid flow paths through the poppet are defined by the first plurality of independent openings and the second plurality of independent openings, wherein fluid flow through the valve assembly occurs when the poppet is in the second position and the fluid flow through the valve assembly passes through plurality of independent fluid flow paths.
